(19) United States
(12) Patent Application Publication
(10) Pub. No.: US 2024/0284028 A1
(43) Pub. Date: Aug. 22, 2024

(54) IMAGING MODULES INCORPORATING A METALENS

(71) Applicant: NIL Technology ApS, Kongens Lyngby (DK)

(72) Inventors: Fredrik Mattinson, Täby (SE); James Eilertsen, Skodsborg (DK); Theodor Nielsen, Copenhagen (DK)

(21) Appl. No.: 18/569,771

(22) PCT Filed: Jun. 9, 2022
(86) PCT No.: PCT/EP2022/065755

§ 371 Date: Dec. 13, 2023

Related U.S. Application Data
(60) Provisional application No. 63/210,857, filed on Jun. 15, 2021.

(51) Int. Cl. H04N 23/55; G02B 1/00; H04N 23/54; H04N 23/60; H04N 23/67

(52) U.S. Cl. CPC H04N 23/55; G02B 1/002; H04N 23/54; H04N 23/64; H04N 23/671

(57) ABSTRACT

An apparatus in some implementations includes a metalens, an image sensor, and an actuator. The metalens is con-figured to generate multiple diffractive orders of an image at respective corresponding focal lengths. The actuator is operable to move at least one of the metalens or the image sensor to each of multiple positions so that a distance between the metalens and the image sensor is adjustable. The distance between the metalens and the image sensor for each respective one of the positions corresponds to a particular one of the focal lengths.

### FIELD OF THE DISCLOSURE

The present disclosure relates to imaging modules that incorporate a metalens.

### BACKGROUND

Various types of optical sensors can be used to detect the proximity of, or distance to, an object (sometimes referred to as a “target”). A proximity sensor, for example, is operable to detect the presence of the target, without any physical contact, when the target enters the sensor's field. In an optical proximity sensor, radiation (e.g., visible or infrared (IR)) is utilized by the sensor to detect the target. Likewise, an optical distance sensor can detect radiation (e.g., visible or IR) reflected by a target, and determine the distance of the sensor to the target based on the detected radiation.

### SUMMARY

The present disclosure describes imaging modules that incorporate a metalens. The imaging modules can be used, in some implementations, for proximity and/or distance sensing.

For example, in one aspect, the present disclosure describes an apparatus that includes a metalens, an image sensor, and an actuator. The metalens is configured to generate multiple diffractive orders of an image at respective corresponding focal lengths. The actuator is operable to move at least one of the metalens or the image sensor to each of multiple positions so that a distance between the metalens and the image sensor is adjustable. The distance between the metalens and the image sensor for each respective one of the positions corresponds to a particular one of the focal lengths.

Some implementations include one or more of the following features. For example, in some instances, the apparatus further includes at least one processor, and one or more memories coupled to the at least one processor. The one or more memories store programming instructions for execution by the at least one processor to determine a respective image size of an object in each of multiple images acquired by the image sensor, wherein each of the multiple acquired images is a respective image captured at a different one of the focal lengths; and to determine a ratio of the respective image size of the object in a first one of the acquired images and a second one of the acquired images. In some implementations, the one or more memories further store programming instructions for execution by the at least one processor to determine a distance to the object based on the ratio. In some instances, the apparatus includes a look-up table, wherein the at least one processor is operable to determine the distance to the object by accessing information stored in the look-up table.

In some implementations, the actuator is operable to move at least one of the metalens or the image sensor to each of at least three different positions.

The present disclosure also describes a method that includes acquiring, by an image sensor, a first image while a first distance separates the image sensor from a metalens, moving at least one of the image sensor or the metalens such that a second distance separates the image sensor from the metalens, and acquiring, by the image sensor, a second image while the second distance separates the image sensor from the metalens. Each of the first and second images corresponds, respectively, to a different one of multiple diffractive orders of an image generated by the metalens.

Some implementations include one or more of the following features. For example, in some instances, the method further includes determining a respective image size of an object in each of the first and second images, and determining a ratio of the image size of the object in the first image and the image size of the object in the first image. The method also can include determining a distance to the object based on the ratio.

In some implementations, the method further includes moving at least one of the image sensor or the metalens such that the first distance separates the image sensor from the metalens, and repeating the operations of: acquiring a first image while a first distance separates the image sensor from a metalens, moving at least one of the image sensor or the metalens such that a second distance separates the image sensor from the metalens, and acquiring a second image while the second distance separates the image sensor from the metalens.

The present disclosure also describes a system that includes a light emitting component operable to emit light toward an object, and an imager operable to sense light reflected by the object. The imager includes a metalens configured to generate multiple diffractive orders of an image at respective corresponding focal lengths. The imager also includes an image sensor, and an actuator operable to move at least one of the metalens or the image sensor to each of multiple positions so that a distance between the metalens and the image sensor is adjustable. The distance between the metalens and the image sensor for each respective one of the positions corresponds to a particular one of the focal lengths.

The present disclosure also describes an apparatus that includes a metalens and an image sensor. The metalens is configured to generate multiple diffractive orders of an image at respective corresponding focal lengths. The image sensor is operable to acquire images of an object, wherein each image corresponds to a different diffractive order of the metalens. The image sensor is disposed at a position between first and second ones of the focal lengths, where the first focal length corresponds to one diffractive order of the metalens, and the second focal length corresponds to another diffractive order of the metalens. The apparatus further includes at least one processor, and one or more memories coupled to the at least one processor. The one or more memories store programming instructions for execution by the at least one processor to determine a distance to the object based on the images acquired by the image sensor.

In some implementations, the one or more memories store programming instructions for execution by the at least one processor to determine a respective image size of the object appearing in a plurality of the images acquired by the image sensor, determine a ratio of the respective image size of the object in a first one of the images and a second one of the images, and determine the distance to the object based on the ratio. In some implementations, the metalens is a telecentric metalens.

In some implementations, the present techniques may provide advantages over other cameras and imagers designed to generate distance data. For example, the footprint of the present camera module may, in some instances, be smaller than stereo cameras (which use a second camera to generate distance data) or structured-light cameras (which use a structured-light generator to project structured light onto an object).

Other aspects, features and advantages will be readily apparent from the following detailed description, the accompanying drawings and the claims.

### BRIEF DESCRIPTION OF THE DRAWINGS

FIG. 1 illustrates an example of a camera module.

FIG. 2A illustrates an example of the camera module in which images of an object at a first distance are acquired.

FIG. 2B illustrates an example of the camera module in which images of an object at a second distance are acquired.

FIG. 3 illustrates an example of the camera module in which images of multiple objects are acquired.

FIG. 4 illustrates an example of a camera module in which the image sensor can be moved between at least three positions.

FIG. 5 is a flow chart of a method in which the image sensor moves between different positions.

FIG. 6 is a flow chart of a method in which the metalens moves between different positions.

FIG. 7 illustrates an example of a system incorporating a camera module.

FIG. 8 illustrates an example of a camera module having a fixed distance between the metalens and the image sensor.

### DETAILED DESCRIPTION

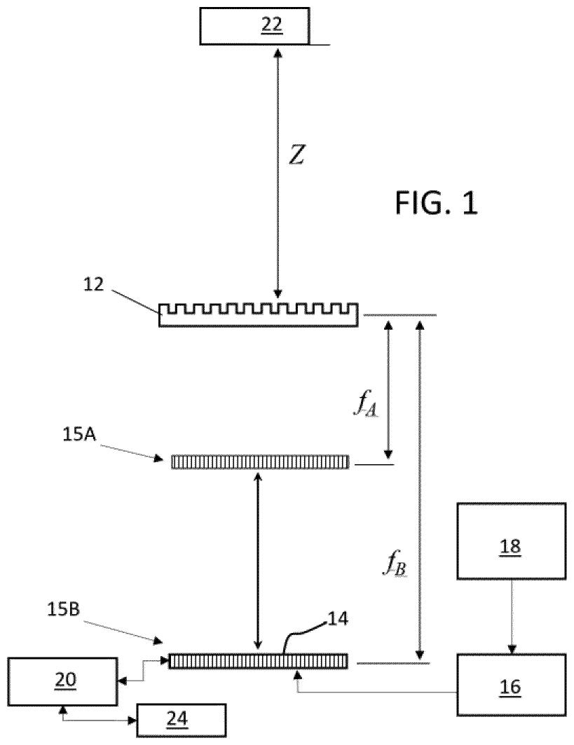

As illustrated in FIG. 1, a camera or other imaging module 10 include an optical metalens 12 configured to generate multiple diffractive orders of an image at different corresponding focal lengths f_{A}, f_{B} where an image sensor 14 (e.g., a CMOS sensor) can be positioned. For example, in the illustrated example, the second focal length fs corresponds to the first diffractive order, and the first focal length f_{A} corresponds to the second diffractive order.

A metalens can include, for example, a metasurface, which refers to a surface with distributed small structures (e.g., meta-atoms or other nano-structures) arranged to interact with light in a particular manner. In the case of a metalens, the meta-atoms are arranged so that the metastructure functions as a lens. Metalenses tend to exhibit low-f numbers. Consequently, they can permit a large amount of light to be focused onto the sensor 14, which can facilitate relatively rapid image exposures in some implementations.

The module 10 further includes at least one actuator 16 to move one, or both, of the metalens 12 or the image sensor 14 so that the distance between the metalens and the image sensor can be adjusted.

As shown in the example of FIG. 1, the actuator 16 is operable to move the image sensor 14 between a first position 15A corresponding to the first focal length f_{A} and a second position 15B corresponding to the second focal length f_{B}. This feature allows the image sensor 14 to capture images representing different diffractive orders of the same image. The terms “first” and “second” in this context do not imply a particular sequence in which the image sensor 14 moves between the positions. That is, in some instances, the image sensor 14 may start in the first position 15A and then move to the second position 15B, whereas in other instances, the image sensor 14 may start in the second position 15B and then move to the first position 15A. Although the illustrated example shows two different positions 15A, 15B for the image sensor 14, in some implementations there may be additional positions for the image sensor, each of which corresponds to a respective focal length for a different diffractive order of the metalens 12. Further, as indicated above, in some implementations, instead of (or in addition to) moving the image sensor 14, the actuator 16 may cause the metalens 12 to move between different positions such that at a first position, the distance to the image sensor corresponds to the first focal length f_{A}, and at a second position, the distance to the image sensor corresponds to the second focal length f_{B}. Here as well, the terms “first” and “second” do not imply a particular sequence in which the metalens 12 moves between the positions. Thus, in some implementations, there are one or more actuators 16 for causing relative movement between the metalens 12 and the image sensor 14.

The actuator 16 can be implemented, for example, as a MEMS, piezoelectric or voice-coil actuator. A microcontroller 18 or other control circuitry is operable to control the actuator 16 to cause movement of the image sensor 14 and/or metalens 12.

Light reflected by an object 22 external to the camera 10 can be collected by the sensor 14 to obtain a respective image at the two or more positions. Read-out and processing circuitry 20, which can include, for example, at least one processor (e.g., a microprocessor) configured to execute instructions stored in memory, can read out and process the acquired images to determine the object's distance from the camera. In general, the ratio (R) of the object image size at the first image sensor position to the object image size at the second image sensor position is proportional to the first distance (Z) to the object 22. Thus, the circuitry 20 can, in some implementations, use image matching techniques to detect edges of the object 22 in the image at each sensor position. The circuitry 20 then can determine the size of the object in each image, determine the ratio of the sizes of the object, and determine the distance Z based on the ratio. In some implementations, the circuitry can access a look-up table 24 that stores a correspondence between the ratio (R) and the distance (Z). In other implementations, the circuitry 20 is operable to perform a calculation to determine the distance (Z) based on the ratio (R).

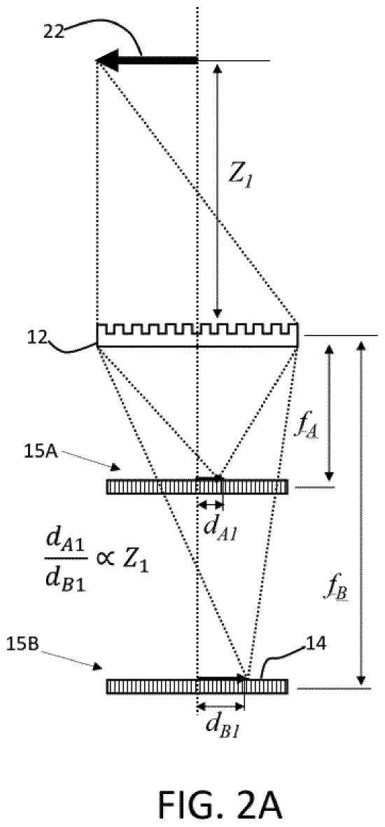

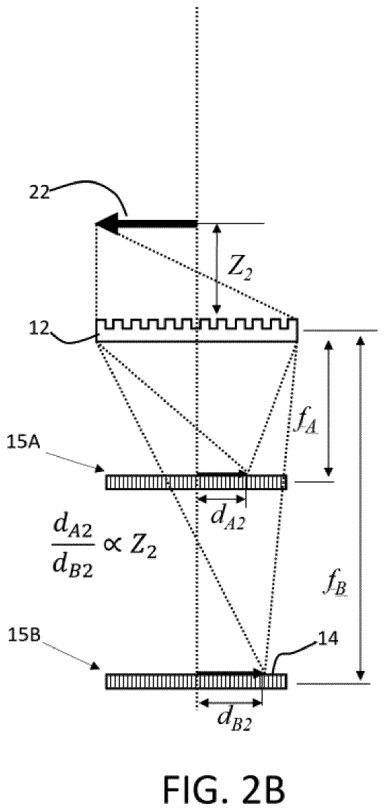

As is apparent from the foregoing description, during image acquisition, the distance between the metalens 12 and the plane of the camera's image sensor 14 can be changed to correspond to different ones of the focal lengths, and a ratio of the sizes of an object in the acquired images can be used to determine the distance to the object. FIGS. 2A and 2B illustrate examples.

In FIG. 2A, an object 22 is located at a first distance Z₁ from the camera module (e.g., a distance Z₁ from the plane of the metalens 12). The image sensor 14 acquires a first image of the object 22 located at the first distance Z₁ while the image sensor is at the first position 15A. While the object 22 is still at a distance Z₁, the image sensor 14 is moved to the second position 15B, and then a second image of the object 22 is acquired by the image sensor 14 while the image sensor is at the second position. The respective object image size (on the sensor) is determined, by the circuitry 20, for each of the acquired images. That is, the circuitry 20 determines the object image size d_{A1} based on the image acquired when the sensor 14 was at the first position 15A, and the circuitry 20 determines the object image size d_{B1} based on the image acquired when the sensor 14 was at the second position 15B. The ratio (d_{A1}/d_{B1}) of the object image size at the first image sensor position to the object image size at the second image sensor position is proportional to the first distance Z₁ and can be determined by the circuitry 20.

In FIG. 2B, the object 22 is located at a second distance Z₂ from the camera module (e.g., a distance Z₂ from the plane of the metalens 12). In the illustrated examples, the distance Z₂ is less than the distance Z₁. The process described in connection with FIG. 2A is repeated while the object 22 is at the second distance Z₂. That is, the image sensor 14 acquires a first image of the object 22 located at the first distance Z₂ while the image sensor is at the first position 15A. While the object 22 is still at a distance Z₂, the image sensor 14 is moved to the second position 15B, and then a second image of the object 22 is acquired by the image sensor 14 while the image sensor is at the second position. The respective object image size (on the sensor) is determined, by the circuitry 20, for each of the images acquired while the object was at the second distance Z₂. That is, the circuitry 20 determines the object image size d_{B1} based on the image acquired when the sensor 14 was at the first position 15A, and the circuitry 20 determines the object image size d_{B2} based on the image acquired when the sensor 14 was at the second position 15B. The ratio (d_{A2}/d_{B2}) of the object image size at the first image sensor position to the object image size at the second image sensor position is proportional to the second distance Z₂ and can be determined by the circuitry 20.

Although FIGS. 2A and 2B depict scenarios in which the same object 22 is at a first distance Z₁ and then at a second distance Z₂, the same principles hold for detecting different objects at different distances. For example, in some instances, an image acquired by the image sensor 14 while at the first position 15A may capture two different objects, and an image acquired by the image sensor while at the second position 15B may capture the same two objects still located at the same respective distances from the camera module. Image matching or other techniques can be used by the circuitry 20 to detect edges of the objects 22 in the images. The circuitry 20 then can determine the image size corresponding to each object in the acquired images and, based on the ratio of the object image size for each particular one of the objects, can determine the respective distance to each object.

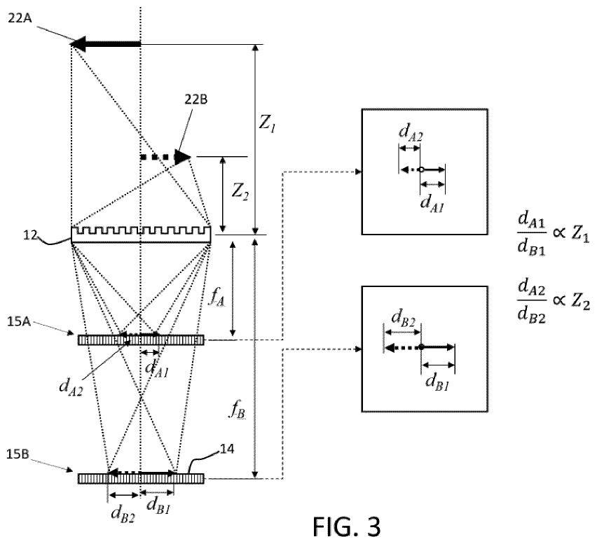

FIG. 3 illustrates an example in which a first object 22A is at a first distance Z₁, and a second object 22B is a second distance Z₂. In this example, the circuitry 20 is operable to acquire images that capture both objects 22A, 22B. The circuitry 20 then can determine the ratio (d_{A1}/d_{B1}) of the object image sizes for the first object 22A and, based on the ratio, can determine the distance Z₁ to that object. Likewise, the circuitry 20 can determine the ratio (d_{A2}/d_{B2}) of the object image sizes for the second object 22B and, based on the ratio, can determine the distance Z₂ to that object.

In some implementations, the foregoing techniques may provide advantages over other cameras and imagers designed to generate distance data. For example, the footprint of the present camera module may, in some instances, be smaller than stereo cameras or structured-light cameras. That is because stereo cameras require a second camera to generate distance data, and structured-light cameras require a structured-light generator to project structured light onto an object.

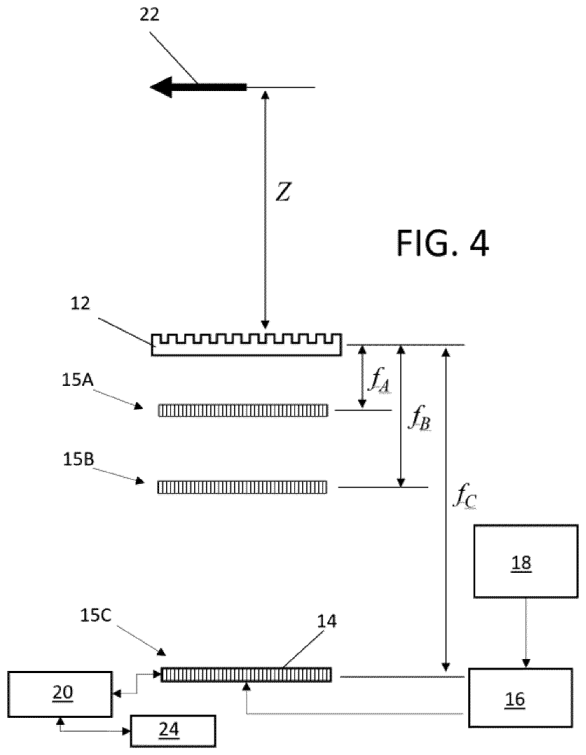

As noted above, in some implementations, the position of one or both of the image sensor 14 and the metalens 12 can be adjusted such that there are more than two possible separation distances between the metalens 12 and the image sensor 14. Each separation distance is equal to a respective focal length corresponding to a different diffractive order of the metalens 12. FIG. 4 illustrates such an example, which shows three positions 15A, 15B, 15C for the image sensor 14, where the first position 15A is at a first focal length f_{A} corresponding to the third diffractive order of the metalens 12, the second position 15B is at a second focal length f_{B} corresponding to the second diffractive order of the metalens 12, and the third position 15C is at a third focal length f_{B} corresponding to the first diffractive order of the metalens 12. As described in connection with FIG. 1, an actuator 16 can be used to move the image sensor 14 (and/or the metalens 12) so as to adjust the distance between the metalens and the image sensor.

The configuration of FIG. 4 also can be used to allow the camera to capture, for example, multiple images at multiple sensor positions. In some instances, additional data can be generated and can be used to improve the accuracy of the distance measurement. For example, in some instances, images are collected at two or more predetermined sensor positions according to the dimensions of the object or according to an estimated distance to the object. In some cases, for instance, an object of a length L1 may be better imaged by the sensor 14 at the first and second positions, whereas an object of a different length L2 may be better imaged by the sensor 14 at the second and third positions. The foregoing feature may prove particularly advantageous when the length L2 is smaller than the length L1. A more accurate object image size may be obtained in some instances because the object image size will be larger at the third image sensor position.

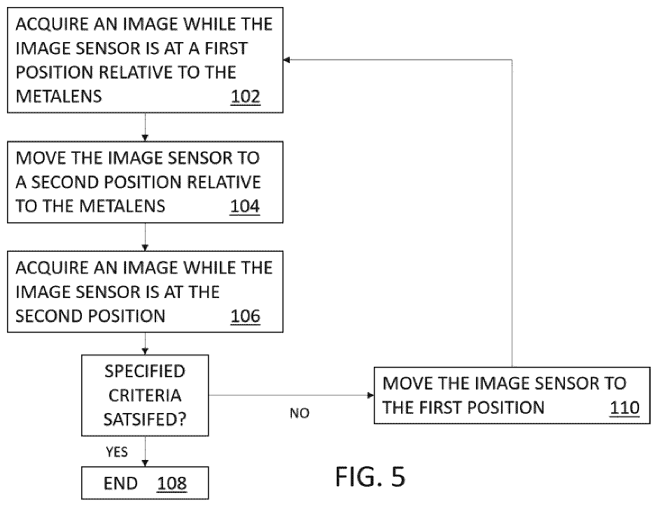

In some implementations, as indicated by FIG. 5, the actuator 16 controls movement of the image sensor 14 such that the image sensor oscillates between multiple positions (e.g., between positions 15A and 15B of FIG. 1). For example, at 102, an image is acquired while the image sensor 14 is at a first position relative to the metalens 12. Then, at 104, the image sensor 14 is moved to a second position relative to the metalens 12, and at 106, an image is acquired while the image sensor 14 is at the second position. If specified criteria are satisfied (e.g., a predetermined number of images have been acquired at each position or a specified duration has elapsed), the process ends (at 108). Otherwise, at 110, the image sensor 14 is moved to the first position, and the process returns to 102.

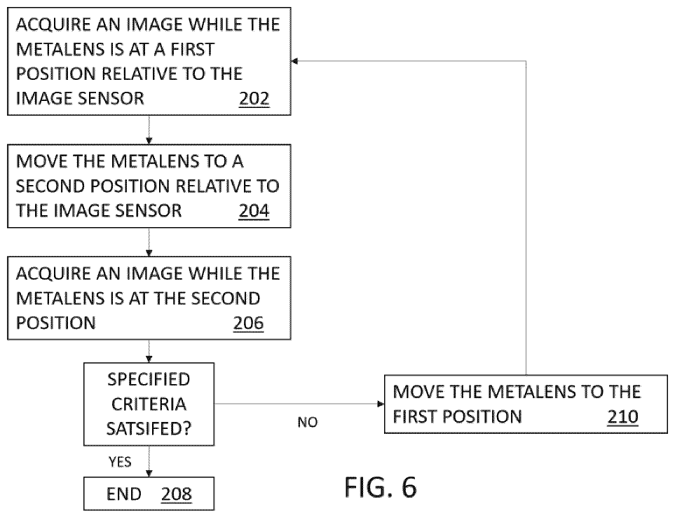

In some implementations, as indicated by FIG. 6, the actuator 16 controls movement of the metalens 12 such that the metalens oscillates between multiple positions. For example, at 202, an image is acquired by the image sensor 14 while the metalens 12 is at a first position relative to the image sensor 14. Then, at 204, the metalens 12 is moved to a second position relative to the image sensor 14, and at 206, an image is acquired by the image sensor 14 while metalens 12 is at the second position. If specified criteria are satisfied (e.g., a predetermined number of images have been acquired for each position or a specified duration has elapsed), the process ends (at 208). Otherwise, at 210, the metalens 12 is moved to the first position, and the process returns to 202.

The oscillation frequency can be controlled, for example, to allow multiple images to be collected such that the accuracy of a distance measurement is improved. The oscillation feature also can be used for other applications (e.g., a video mode of operation).

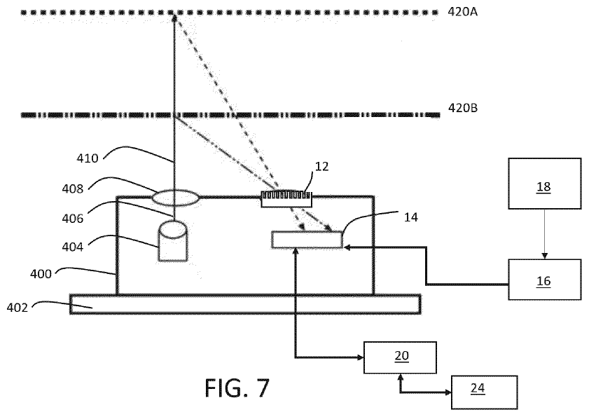

In some cases, as shown in FIG. 7, the image sensor 14 can be provided in a housing 400. A light emitting component (e.g., a vertical-cavity surface-emitting laser or a light-emitting diode) 404 also can be included within the housing 400. In some instances, the light emitting component 404 and/or the image sensor 14 can be mounted on, or formed in, a substrate 402. Light (e.g., infra-red or visible) 406 generated by the light-emitting component 404 can be transmitted through an optical device 408 (e.g., DOE or lens), which is operable to interact with the light 406, such that modified light 410 is transmitted out of the module 400. In some implementations, the light 410 emitted from the module may interacts with, and at least partially be reflected by, an object external to the module 400. Some of the reflected light can be received by the module 400 (e.g., through the metalens 12) and sensed by the image sensor 14. As described above, the distance between the metalens 12 and the image sensor 14 can be adjusted so that multiple images of the object can be acquired, where each of the acquired images of the object corresponds to a different diffractive order of the metalens 12. The images then can be processed, for example, as described above for proximity or distance sensing (e.g., to determine that the object is at a first distance (e.g., in a first plane 420A) or at a second distance (e.g., in a second plane 420B).

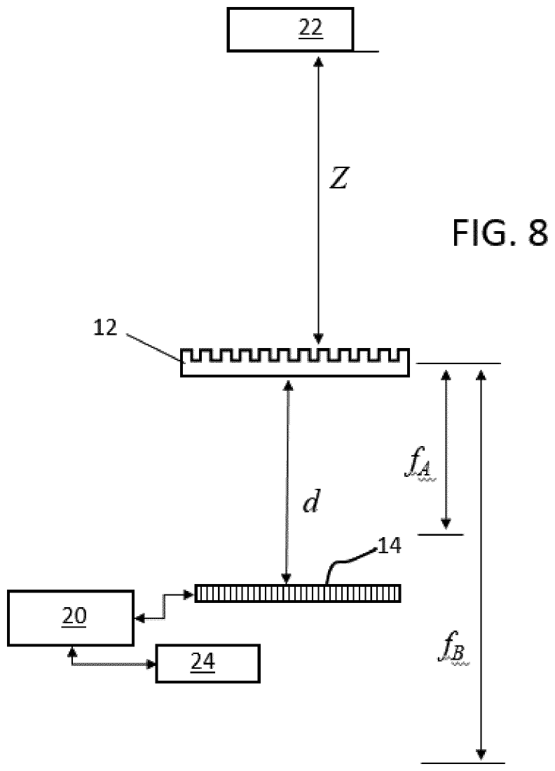

Although the foregoing examples include an actuator to facilitate movement of the sensor or metalens between various positions as described above, in other implementations, the actuator may be omitted. For example, in some implementations, as shown in FIG. 8, the distance d between the plan of the image sensor 14 and metalens 12 is fixed, and the distance d between them is chosen such that two or more images of an object 22 appear on the image plane and can be acquired by the sensor 14. In the illustrated example, the image sensor 14 is located at a position between first and second focal lengths of the metalens 12, where the first focal length f_{A} corresponds to one diffractive order of the metalens (e.g., the second diffractive order), and the second focal length f_{B} corresponds to another diffractive order of the metalens (e.g., the first diffractive order).

Although the fixed distance d may be less than ideal for acquiring either image alone, it can, in some instances, be good enough to perform a disparity calculation as explained above. That is, light reflected by the object 22 can be collected by the sensor 14 to obtain images of the object 22, where each image corresponds to a different diffractive order of the metalens 12. The read-out and processing circuitry 20, which can include, for example, at least one processor (e.g., a microprocessor) configured to execute instructions stored in memory, can read out and process the acquired images to determine the object's distance from the camera. In general, the ratio (R) of the object image sizes is proportional to the first distance (Z) to the object 22. Thus, the circuitry 20 can, in some implementations, use image matching techniques to detect edges of the object 22 in the images. The circuitry 20 then can determine the size of the object in each image, determine the ratio of the sizes of the object, and determine the distance Z based on the ratio. As explained above, in some implementations, the circuitry can access a look-up table 24 that stores a correspondence between the ratio (R) and the distance (Z). In other implementations, the circuitry 20 is operable to perform a calculation to determine the distance (Z) based on the ratio (R).

In some implementations, the metalens 12 of FIG. 8 is a telecentric metalens configured such that the image appearing on the image sensor is substantially the same size even if there is a change in the distance d.

Various aspects of the subject matter and the functional operations described in this specification (e.g., the microprocessor 18 and/or processing circuitry 20) can be implemented in digital electronic circuitry, or in computer software, firmware, or hardware, or in combinations of one or more of them. Thus, aspects of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The apparatus can include, in addition to hardware, code that creates an execution environment for the computer program in question, e.g., code that constitutes processor firmware.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Features described in connection with different implementations can, in some instances, be combined in the same implementation. Further, various other modifications can be made to the foregoing examples. Thus, other implementations also are within the scope of the claims.

1. An apparatus comprising:
a metalens configured to generate a plurality of diffractive orders of an image at respective corresponding focal lengths;
an image sensor; and
an actuator operable to move at least one of the metalens or the image sensor to each of a plurality of positions so that a distance between the metalens and the image sensor is adjustable, wherein the distance between the metalens and the image sensor for each respective one of the positions corresponds to a particular one of the focal lengths.

2. The apparatus of claim 1 wherein the actuator is operable to move the image sensor to each of the plurality of positions.

3. The apparatus of claim 1 wherein the actuator is operable to move the metalens to each of the plurality of positions.

4. The apparatus of claim 1 further including:
at least one processor; and
one or more memories coupled to the at least one processor and storing programming instructions for execution by the at least one processor to:
determine a respective image size of an object in each of a plurality of images acquired by the image sensor, wherein each of the plurality of acquired images is a respective image captured at a different one of the focal lengths; and
determine a ratio of the respective image size of the object in a first one of the acquired images and a second one of the acquired images.

5. The apparatus of claim 4 wherein the one or more memories further store programming instructions for execution by the at least one processor to:
determine a distance to the object based on the ratio.

6. The apparatus of claim 5 further including a look-up table, wherein the at least one processor is operable to determine the distance to the object by accessing information stored in the look-up table.

7. The apparatus of claim 1 wherein the plurality of positions includes at least three different positions.

8. A method comprising:
(a) acquiring, by an image sensor, a first image while a first distance separates the image sensor from a metalens;
(b) moving at least one of the image sensor or the metalens such that a second distance separates the image sensor from the metalens; and
(c) acquiring, by the image sensor, a second image while the second distance separates the image sensor from the metalens;
wherein each of the first and second images corresponds, respectively, to a different one of a plurality of diffractive orders of an image generated by the metalens.

9. The method of claim 8 wherein moving at least one of the image sensor or the metalens includes moving the image sensor.

10. The method of claim 8 wherein moving at least one of the image sensor or the metalens includes moving the metalens.

11. The method of claim 8 further including:
determining a respective image size of an object in each of the first and second images; and
determining a ratio of the image size of the object in the first image and the image size of the object in the first image.

12. The method of claim 11 further including:
determining a distance to the object based on the ratio.

13. The method of claim 8 further including:
moving at least one of the image sensor or the metalens such that the first distance separates the image sensor from the metalens; and
repeating (a), (b) and (c).

14. A system comprising:
a light emitting component operable to emit light toward an object;
an imager operable to sense light reflected by the object, the imager including:
a metalens configured to generate a plurality of diffractive orders of an image at respective corresponding focal lengths;
an image sensor; and
an actuator operable to move at least one of the metalens or the image sensor to each of a plurality of positions so that a distance between the metalens and the image sensor is adjustable, wherein the distance between the metalens and the image sensor for each respective one of the positions corresponds to a particular one of the focal lengths.

15. The system of claim 14 further including:
at least one processor; and
one or more memories coupled to the at least one processor and storing programming instructions for execution by the at least one processor to:
determine a respective image size of an object in each of a plurality of images acquired by the image sensor, wherein each of the plurality of acquired images is a respective image captured at a different one of the focal lengths; and
determine a ratio of the respective image size of the object in a first one of the acquired images and a second one of the acquired images.

16. The system of claim 15 wherein the one or more memories further store programming instructions for execution by the at least one processor to:
determine a distance to the object based on the ratio.

17. An apparatus comprising:
a metalens configured to generate a plurality of diffractive orders of an image at respective corresponding focal lengths;
an image sensor operable to acquire images of an object, wherein each image corresponds to a different diffractive order of the metalens, the image sensor being disposed at a position between first and second ones of the focal lengths, where the first focal length corresponds to one diffractive order of the metalens, and the second focal length corresponds to another diffractive order of the metalens;
at least one processor; and
one or more memories coupled to the at least one processor and storing programming instructions for execution by the at least one processor to:
determine a distance to the object based on the images acquired by the image sensor.

18. The apparatus of claim 17 wherein the one or more memories store programming instructions for execution by the at least one processor to:
determine a respective image size of the object appearing in a plurality of the images acquired by the image sensor;
determine a ratio of the respective image size of the object in a first one of the images and a second one of the images; and
determine the distance to the object based on the ratio.

19. The apparatus of claim 17, wherein the metalens is a telecentric metalens.

20. The apparatus of claim 18, wherein the metalens is a telecentric metalens.
